(19) United States
(12) Patent Application Publication
(10) Pub. No.: US 2024/0359238 A1
(43) Pub. Date: Oct. 31, 2024

(54) METHODS AND APPARATUS RELATING TO THE MACHINING OF OPHTHALMIC LENSES

(71) Applicant: CooperVision International Limited, Fareham (GB)

(72) Inventors: Robert OAG, Southampton (GB); David RICKETTS, Southampton (GB); Robert TURNER, Chandler's Ford (GB); Edward James Harley EVANS, Southampton (GB); Robert CHISHOLM, Amesbury (GB)

(73) Assignee: CooperVision International Limited, Fareham (GB)

(21) Appl. No.: 18/640,005

(22) Filed: Apr. 19, 2024

Related U.S. Application Data
(60) Provisional application No. 63/461,605, filed on Apr. 25, 2023.

(51) Int. Cl. B23B 5/36; A45C 11/04; G02C 7/04

(52) U.S. Cl. CPC B23B 5/36; A45C 11/046; G02C 7/04

(57) ABSTRACT

A method of producing an ophthalmic lens member is disclosed. The method comprises mounting an ophthalmic lens member blank 16 on a mandrel 1 for machining. The mandrel 1 has a front surface 6 comprising a planar surface region 10, a curved surface region 8 and a tool trench 12 located between the curved surface region 8 and the planar surface region 10. The method comprises mounting the mandrel 1 on a machine tool; and then severing a portion of the ophthalmic lens member blank 16 by passing a cutting tool 70 through the ophthalmic lens member blank 16 until a portion of the cutting tool 70 is received in the tool trench 12. A mandrel 1 suitable for use in the method is also disclosed.

This application claims the benefit under 35 U.S.C. § 119(e) of prior U.S. Provisional Patent Application No. 63/461,605, filed Apr. 25, 2023, which is incorporated in its entirety by reference herein.

The present disclosure concerns the machining of ophthalmic lenses, more particularly, but not exclusively, contact lenses. The disclosure concerns a method of producing an ophthalmic lens member, a mandrel for holding an ophthalmic lens member blank during machining, and a batch of ophthalmic lenses comprising a lens member machined using such a mandrel and/or method.

### BACKGROUND

Ophthalmic lenses can be produced by machining an ophthalmic lens blank, for example to provide a desired shape or surface finish. A high degree of accuracy and precision in such operations is necessary in order to ensure the finished lens has the required properties. A rod-like mandrel is used to hold the ophthalmic lens blank during machining, for example to mount the lens blank on a lathe for cutting, or to hold the lens blank during polishing or grinding.

Typically, a block of wax is provided on a front surface of the mandrel, and the lens blank is pushed into the wax which then sets and holds the lens blank in place. It is difficult to obtain accurate placement of the lens blank on the wax and a consistent thickness of the wax. This can lead to machining errors as a result of the lens blank being out of position or tilted relative to the mandrel. It would be advantageous to provide a way of holding an ophthalmic lens blank during machining that reduced machining errors and/or provided a lens having an improved optical performance.

Recently, ophthalmic lens assemblies in which optical components are contained within the lens have been proposed. Examples of optical components include diffractive optical elements, and electrically-switchable components, including liquid crystal cells. Such assemblies can be produced by encapsulating the optical components between a first lens member and a second lens member. The first and second lens member may between them define the anterior and posterior surfaces of the lens, or the first and second lens member may define an encapsulation component that is subsequently encapsulated within lens material to form the anterior and/or posterior surfaces of the lens. It would be advantageous to provide an efficient way of machining such lens assemblies. Such assemblies may require more accurate machining in order to achieve the required dimensions in view of the number of components involved (e.g., in view of tolerance stacking) and/or may require a higher level of precision in machining in order to allow the optical components to provide the required effects. More accurate and/or precise machining techniques may therefore be particularly advantageous when applied to such ophthalmic lens assemblies.

Often the first and second lens members of such lens assemblies are of different types. In a first type of lens member each of the anterior surface and posterior surface of the member is curved over the majority, for example substantially the whole of, its surface area. It may be that lens members of the first type do not comprise a planar region, or in particular a planar region extending radially inward from the edge of the member (a flange). This type of lens member may be referred to as a ‘cap’. In a second type of lens member the anterior and/or posterior surface comprises a planar surface region, for example extending radially inwards from the edge of the member. Typically, the planar surface region is an annular surface region surrounding and concentric with a curved surface region centrally located on the member. Lens members of the second type may comprise a flange. This type of lens member may be referred to as a carrier. A lens assembly may be formed by placing a cap on top of a carrier. Many of the machining techniques proposed to date in connection with such lens assemblies provide increased accuracy, precision and/or efficiency for lens members of the second (carrier) type but not the first (cap) type. It would be advantageous to provide methods for more efficiently, precisely and/or more accurately machining lens members of the first type.

The present disclosure seeks to mitigate the above-mentioned problems. Alternatively or additionally, the present disclosure seeks to provide improved apparatus and/or methods for use in machining ophthalmic lenses.

### SUMMARY

In a first aspect, the present disclosure provides a method of producing an ophthalmic lens member, the method comprising:
mounting an ophthalmic lens member blank on a mandrel for machining, the mandrel having a front surface comprising a planar surface region, a curved surface region and a tool trench located between the curved surface region and the planar surface region; and
mounting the mandrel on a machine tool; and then
severing a portion of the ophthalmic lens member blank by passing a cutting tool through the ophthalmic lens member blank until a portion of the cutting tool is received in the tool trench.

In a second aspect, the present disclosure provides a mandrel for holding an ophthalmic lens member blank during machining, the mandrel having a front surface for receiving an ophthalmic lens member blank to be machined; the front surface comprising;
a planar surface region;
a curved surface region; and
a tool trench located between the curved surface region and the planar surface region; wherein the depth of the tool trench is at least 150 μm when measured with respect to the planar surface region.

In a third aspect, the present disclosure provides an ophthalmic lens and/or a batch of at least 1000 ophthalmic lenses, the or each lens comprising at least one ophthalmic lens member produced using the method of the first or fourth aspects and/or the mandrel of the second aspect.

In a fourth aspect, the present disclosure provides a method of producing a contact lens comprising at least one contact lens member, the method comprising producing the contact lens member using the method of the first aspect and/or the mandrel of the second aspect.

Optional but preferred features are set out in the dependent claims.

It will of course be appreciated that features described in relation to one aspect of the present disclosure may be incorporated into other aspects of the present disclosure. For example, the method of the disclosure may incorporate any of the features described with reference to the apparatus of the disclosure and vice versa.

### DESCRIPTION OF THE DRAWINGS

Example embodiments will now be described, by way of example only, with reference to the accompanying schematic drawings, of which:

FIG. 1A shows a mandrel according to an embodiment of the disclosure;

FIG. 1B shows a front view of the mandrel of FIG. 1A;

FIG. 2 shows a mandrel according to an embodiment of the disclosure;

FIG. 3 shows a mandrel according to an embodiment of the disclosure;

FIG. 4 shows a mandrel according to an embodiment of the disclosure;

FIG. 5 shows a mandrel according to an embodiment of the disclosure;

FIG. 6 shows a mandrel according to an embodiment of the disclosure;

FIG. 7 shows a mandrel according to an embodiment of the disclosure;

FIG. 8 shows a flow chart of a method of producing an ophthalmic lens member blank in accordance with the present disclosure;

FIG. 9 shows a blister package according to an embodiment of the disclosure;

FIG. 10A shows values of Zernike coefficients of tilt and other low-order optical aberration terms for a lens member lathed using the previous methods involving a rod-like mandrel;

FIG. 10B shows values of Zernike coefficients of tilt and other low-order optical aberration terms for a lens member lathed and cut using the method and mandrel of the present disclosure, when the lens member has a concave region and no peripheral flange;

FIG. 11 shows a lens; and

FIG. 12 shows a lens produced using the method of the disclosure.

### DETAILED DESCRIPTION

According to a first aspect of the disclosure, there may be provided a method of producing an ophthalmic lens member. The method comprises mounting an ophthalmic lens member blank (hereafter a blank) on a mandrel for machining, the mandrel having a front surface comprising a planar surface region, a curved surface region and/or a tool trench. The tool trench may be located between the curved surface region and the planar surface region. The method may comprise mounting the mandrel on a machine tool, for example before or after the blank is mounted on the front surface. The method may comprise severing a portion of the blank, for example by passing a cutting tool through the blank until a portion of the cutting tool is received in the tool trench.

Thus, the tool trench may be used in reshaping (e.g., changing the dimensions of the peripheral edge of) the blank. Methods in accordance with the present disclosure may increase the range of lens shapes that can be produced using this type of mandrel while enabling the planar surface region of the mandrel to be used to more accurately, precisely and/or reliably locate the lens member blank on the curved surface region, for example by a portion of the lens member blank abutting the planar surface region to reduce tilt and/or centre the blank on the curved region. The tool trench may reduce and/or prevent contact between the cutting tool and the mandrel, thereby reducing the risk of damage to the tool and/or mandrel.

The method may comprise placing the ophthalmic lens member blank on the mandrel with a planar surface region of the ophthalmic lens member blank abutting the planar surface region of the mandrel.

The front surface of the mandrel may comprise a drainage channel. The drainage channel may be located radially inboard or outboard of the tool trench. The drainage channel may be located in the curved surface region or the planar surface region.

The method may comprise mounting the blank on the front surface of the mandrel using wax. The method may comprise applying wax to a region of the mandrel such that said wax retains the blank on the mandrel once cured. Said wax may be applied before or after the blank is placed on the mandrel. It may be that said wax is retained by the drainage channel such that substantially no wax flows into the tool trench, for example such that substantially no wax flow from the region to which it is applied to the tool trench. As used herein, ‘substantially’ can encompass at least 50%, at least 75%, at least 90%, at least 99%. Thus, here, for ‘substantially no wax flows’ would encompass the meaning of where at least 50%, at least 75%, at least 90%, at least 99% by weight of the total wax present does not flow in the tool trench.

Thus, the drainage channel may reduce and/or eliminate the flow of excess wax into the tool trench, thereby reducing and/or eliminating contamination of the cutting tool with wax, which contamination may introduce defects into the machined lens. The method may comprise excess wax from the front surface of the mandrel being retained by the drainage channel. It may be that excess wax from the front surface flows to a back surface and/or edge of the mandrel via the drainage channel.

Mounting the blank on the front surface of the mandrel may comprise applying wax to the curved surface region. It may be that placing the blank on the wax causes wax to flow into the drainage channel from the curved surface region. The method may comprise pushing the blank onto the mandrel, for example onto the wax, until the blank abuts the planar surface region.

Provision of a drainage channel may assist in accurately and/or precisely locating the lens member blank on the curved surface region by reducing and/or eliminating the flow of wax from the curved surface region to the planar surface region where the presence of wax could lead to misalignment between the lens member blank and the mandrel. Provision of a drainage channel may assist in accurately and/or precisely locating the lens member blank on the curved surface region by reducing and/or eliminating the flow of wax from the curved surface region to the tool trench where it may contaminate the cutting tool.

It may be that wax from the curved surface region is retained by the drainage channel such that substantially no wax flows from the curved surface region of the front surface to the tool trench and/or the planar surface region of the front surface.

It may be the mandrel comprises one or more through holes, extending from a back surface of the mandrel to the front surface of the mandrel. It may be that mounting the blank on the front surface of the mandrel comprises providing wax to said through hole(s) via an opening of the through hole on the back surface of the mandrel. Thus, the method may comprise mounting the ophthalmic lens member on the mandrel using wax applied from the back of the mandrel. This may reduce or eliminate the need to apply wax to the front surface of the mandrel, and thereby reduce or eliminate the risk of residual wax on an optical surface of the lens member which must subsequently be removed.

The method may comprise placing the blank on the front surface on the mandrel, and then providing wax to said through holes(s). This may assist in more accurately and/or precisely locating the blank on the mandrel by reducing or eliminating the need to apply wax to the front surface. It may be that no wax is applied to the curved surface region during the method of the present disclosure.

It may be that said portion severed from the blank is retained on the mandrel by wax located in said through hole(s). Thus, it may be that the wax used to mount the blank to the mandrel also retains said portion severed from the blank. It may be that said through hole(s) are located in the planar surface region of the front surface of the mandrel.

It may be that wax from the through hole(s) and/or planar surface region is retained by the drainage channel such that substantially no wax flows from the through hole(s)/planar surface region to the tool trench and/or the curved surface region. Thus, the drainage channel may reduce the risk of wax from the through-holes/planar surface region reaching an optical surface of the lens member located adjacent the curved surface region of the mandrel.

In addition to severing a portion of the blank, the method may comprise machining the anterior and/or posterior surfaces of the blank while the blank is mounted on the mandrel. It will be appreciated that, as used herein, severing a portion of the blank changes the shape of the peripheral (radially outermost) edge of the blank, while machining may change the shape of the anterior and/or posterior surface of the blank while leaving the shape of the peripheral edge of the blank substantially unchanged. The severing of a portion of the blank may result in a reduction in the maximum diameter of the blank. The step of severing a portion of the blank may be carried out after machining the anterior and/or posterior surfaces of the blank.

The term machining may refer to cutting, grinding, polishing and/or other machining processes. Examples of machine tools with which the present disclosure may find application include lathes, grinding machines, polishing machines and/or other machine tools.

In use, the blank may be received on the front surface of the mandrel in an abutting relationship with the planar surface of the mandrel. In the case that the curved surface region of the mandrel is convex, the posterior surface of the blank may comprise and/or define a recess in which the curved surface region of the mandrel is received. In the case that the curved surface region of the mandrel is concave, the anterior surface of the blank may comprise and/or define a dome which is received in the bowl defined by the curved surface region of the mandrel.

The method may comprise allowing the wax to set. The method may comprise releasing the hold on the blank (e.g., after the wax has set) and the blank being retained by the wax.

The method may comprise shaping the peripheral edge of the blank after said portion has been severed, for example using the cutting tool. It may be that said shaping step changes the cross-sectional profile of the edge (e.g., the shape when viewed in a plane perpendicular to the tangent of the edge and passing through the geometric axis of the blank) but does not substantially change the dimensions of the blank (e.g., the dimensions do not change by more than 5% or more than 1% or more than 0.5%).

The method may comprise mounting the mandrel on a machine tool. For example, the mandrel may be mounted on the machine tool by inserting the stem of the mandrel into a chuck. The method may comprise machining the anterior surface and/or the posterior surface of the blank. The method may comprise releasing the blank from the mandrel, for example by melting the wax. The method may comprise carrying out further finishing steps on the ophthalmic lens member. It will be appreciated, that methods of the present disclosure produce ophthalmic lens members by machining blanks. Thus, an ophthalmic lens member is an ophthalmic lens member blank after machining has been completed (including shaping of the surfaces of the blank and/or severing of said portion).

Severing said portion of the blank may comprise passing the cutting tool along the tool trench while said portion of the tool is received therein, for example along the majority of, for example along substantially the entire length of the tool trench (e.g., 50% or more, 75% or more, 90% or more, at least 95%, or at least 99% of the entire length). The tool trench may extend circumferentially around the axis of rotation of the mandrel. Severing said portion may comprise passing the cutting tool around the axis of rotation of the mandrel while said portion of the cutting tool is received in the tool trench, for example at a constant radial distance from the axis of rotation of the mandrel. Severing said portion may comprise moving the cutting tool through a range of at least 180 degrees, for example at least 270 degrees, for example 360 degrees or more around the axis of rotation of the mandrel.

The method may comprise rotating the mandrel relative to the cutting tool and it may be that said portion is severed while the mandrel is rotating relative to the tool. Thus, it may be that the cutting tool moves along the tool trench while the mandrel is rotating relative to the tool.

It may be that the blank comprises an anterior and/or posterior surface having a planar surface region. A blank may have an anterior surface, being the front surface when the lens is in use on the eye. A blank may have a posterior surface, being the rear surface when the lens is in use on the eye. The anterior and/or posterior surfaces of the blank may have, comprise, consist essentially of, and/or consist of a curved surface region and said planar surface region. The method may comprise severing at least part of said planar surface region, for example the majority (by surface area), for example substantially the whole of, the planar surface region (e.g., 50% or more, 75% or more, 90% or more, at least 95%, or at least 99% of the entire planar surface region). Thus, it may be that said portion of the blank that is severed comprises and/or defines said planar surface region. Thus, the method may comprise severing a portion of the blank to provide a ‘cap’. It may be that said portion of the blank that is severed is annular. It may be that said planar surface region extends radially inwards from the edge of the blank on the posterior and/or anterior sides of the blank. It may be that said planar surface region(s) comprises and/or defines a flange surrounding a curved surface region of the blank, and severing said portion of the blank removes the majority of (by surface area), for example substantially the whole of, said flange (e.g., removes 50% or more, 75% or more, 90% or more, at least 95%, or at least 99% of the flange surface area).

The blank may comprise an optic zone and said planar surface region and/or said portion severed from the lens may be an annular planar surface region surrounding said optic zone. The optic zone of a lens, lens member or lens member blank may be centred on the optical axis. The optic zone encompasses the parts of the lens that have optical functionality in use. The optic zone may be configured to be positioned over or in front of the pupil of an eye when in use.

It may be that the blank is placed on the front surface of the mandrel such that a portion of the blank, e.g., a planar surface portion, extends across the tool trench and/or drainage channel (if present) from the curved surface region of the mandrel to the planar surface region of the mandrel, such that passing the cutting tool through the blank causes the portion of the blank extending radially beyond the tool trench to be severed.

The posterior surface of the blank may comprise a concave (e.g., bowl-shaped) region, for example surrounded by a planar region. The anterior surface of the blank may comprise a convex (e.g., dome-shaped) region, for example surrounded by a planar region. Either of the anterior or posterior surface may be positioned adjacent the front surface of the mandrel to enable machining of the other of the anterior or posterior surface. In this context, the surface of the blank adjacent the front surface of the mandrel is referred to herein as the rear surface of the blank, and the other surface of the blank as the front surface. Thus, at different times the anterior surface of a blank may be referred to as the front surface and the rear surface, depending on the orientation of the blank on the mandrel. It may be that the mandrel has a convex (dome-shaped) curved surface region when the anterior surface of the lens member blank is being machined and the posterior surface is adjacent the front surface. It may be that the mandrel has a concave (bowl-shaped) curved surface region when the posterior surface of the lens member blank is being machined and the anterior surface is adjacent the front surface. Providing a front surface that conforms to the shape of the lens member blank being machined may provide improved accuracy and/or precision in positioning the lens member on the mandrel.

The method may include placing one of the anterior and posterior surfaces of the blank against the front surface of a mandrel as described above, and then machining the other of the anterior and posterior surfaces (and optionally carrying out any of the other method steps described above or below with the lens member blank mounted on the mandrel in that orientation). The method may comprise removing the blank from the mandrel after the machining of that surface is complete. The method may then be repeated to machine the other of the anterior and posterior surface of the same blank. The method may comprise placing a machined one of the anterior and posterior surfaces of the blank against the front surface of a mandrel as described, and then machining the other of the anterior and posterior surfaces (and optionally carrying out any of the other method steps described above or below with the blank mounted on the mandrel in that orientation). The method may then comprise severing a portion of the blank with a cutting tool by passing the cutting tool through the blank until a portion of the cutting tool is received in the tool trench after the anterior and/or posterior surfaces have been machined. The method may comprise removing the blank (which may at that stage of the process be referred to as a lens member) from the mandrel after said portion has been severed.

It may be that said portion of the blank that is severed comprises an annular portion of the blank.

It may be that the machining comprises cutting, for example on a lathe, polishing or grinding, or any other machining operation where the lens must be held and supported.

It may be that the front surface of the mandrel comprises a front-recess in which at least a portion of the blank is received when mounted on the mandrel. The front-recess may be defined by one or more sidewalls and a base. The method may comprise pushing the blank onto the mandrel until the planar surface region of the blank is abutting the base of the front-recess. The tool trench and/or drainage channel (if present) may be located in the base of the front-recess.

It may be that said portion severed from the blank is retained on the mandrel after it has been severed. Retaining the portion on the mandrel may reduce the risk of damage to the remaining portion of the lens member blank and/or increase the safety of the manufacturing process.

It may be the mandrel comprises one or more recesses in the planar surface region. It may be that said portion severed from the blank is retained on the mandrel by wax located in said recess(es). The method may comprise providing wax to said recess(es) after the blank has been mounted on the mandrel using the wax applied to the curved surface region. Thus, the method may comprise placing the blank on the wax applied to the curved surface region, allowing that wax to set, and then applying wax to said recess(es), for example from the rear of the mandrel. Providing the wax to the recess(es) after the blank has been mounted on the mandrel may prevent the wax in the recess(es) overflowing or otherwise impacting on the alignment of the blank on the mandrel. It may be that said recess(es) are through-hole(s) extending from the back surface of the mandrel to the front surface of the mandrel. It may be that wax is provided to each of said through-holes via an opening of the through-hole on the back surface of the mandrel. The use of through-holes may provide a mechanically simple and straightforward way of providing the wax to the recess(es) after the blank has been mounted on the mandrel.

Additionally or alternatively, said recess(es) may be in fluid communication with the region to which wax is applied when mounting the blank on the mandrel. For example, the recess(es) may be in fluid communication with the curved surface region of the mandrel such that wax applied to the curved surface region flows from the curved surface region to the recess(es), e.g., when the blank is pressed onto the mandrel. The mandrel may comprise one or more flow passages, e.g., extending beneath the tool trench, for example from the curved surface region to the planar surface region, such that wax can flow to the recess(es) without entering the tool trench.

It may be that said portion severed from the blank is retained on the mandrel by one or more retaining members. The or each retaining member may be mounted on the mandrel. The method may comprise the retaining member moving from a first configuration, in which the retaining member allows the blank to move relative to the mandrel, to a second configuration in which the retaining member prevents movement relative to the mandrel of at least a portion of the blank located radially outside the tool trench. It may be that in the second configuration the retaining member presses a portion of the blank against the planar surface region of the mandrel. It may be that the retaining member is biased towards the second configuration. For example, the retaining member can be resiliently deformable. Additionally or alternatively, the mandrel may comprise a resiliently deformable member, for example a spring, configured to bias the retaining member towards the second configuration. Thus, the retaining member may be or form part of a clip. Additionally or alternatively, the mandrel may comprise a clamp member configured to hold the retaining member in the second configuration. The mandrel or the retaining member may be a threaded member, for example a bolt or screw. For example, the mandrel may comprise a threaded member connectable to the retaining member and the rest of the mandrel such that rotation of the threaded member causes the retaining member to clamp a portion of the ophthalmic lens member blank against the mandrel. Thus, the retaining member may be or form part of a clamp.

It may be that said portion severed from the blank is retained on the mandrel by a retaining member, wherein said retaining member is a resiliently deformable member, for example located in the front-recess of the mandrel. The resiliently deformable member may be an annular member. It may be that said resiliently deformable member is deformed, for example compressed, during the step of placing the blank on the wax. Thus, the method may comprise pushing the blank onto the mandrel until the planar surface region of the blank is abutting the base of the front-recess and thereby deforming the resiliently deformable member. It may be that the blank is mounted on the mandrel such that the resiliently deformable member is located between the edge of the blank and the base and/or side wall(s) of the front-recess. In this case, the first configuration of the retaining member may be an uncompressed state, and the second configuration may be a compressed state.

The resiliently deformable member may be an o-ring (an annular member with a cylindrical or oval cross section or substantially cylindrical or oval cross section (from appearance) when viewed in a plane parallel to the axis of rotational symmetry of the o-ring), washer (an annular member with a square or rectangular cross-section when viewed in a plane parallel to the axis of rotational symmetry of the washer), or take any other suitable form that is compatible with the shape of the front-recess and the edge of the lens member blank.

It may be that said portion severed from the blank is retained on the mandrel using a magnet. For example, the mandrel may comprise one or more first magnets. It may be that one or more second magnets are located on the other side of the blank to the first magnet such that the said portion severed from the blank is retained on the mandrel by the attractive force between the first and second magnets. Alternatively, a magnetic member (being a member of magnetic material) may be located on the other side of the blank to the first magnet such that the said portion severed from the blank is retained on the mandrel by the attractive force between the first magnet(s) and the magnetic member. The front surface of the mandrel may comprise one or more ridges arranged to limit the radial movement of the second magnet(s) and/or magnetic member(s), for example arranged to prevent the second magnet(s) and/or magnetic member(s) moving radially outwards as the mandrel rotates relative to the cutting tool.

The method may comprise heating the mandrel, for example before or during applying wax to the mandrel. Thus, the method may comprise raising the temperature of the mandrel above the ambient. This may increase the time for which the wax runs, and therefore assist in correct mounting of the blank on the mandrel. The mandrel may be heated by placing it on a hot plate.

In a second aspect of the invention, there is provided a mandrel for holding an ophthalmic lens member blank during machining, the mandrel having a front surface for receiving an ophthalmic lens member blank to be machined; the front surface comprising; a planar surface region; a curved surface region; and/or a tool trench.

The tool trench may extend along a portion of, for example the majority of, for example the whole of, the (e.g., notional) boundary between the curved surface region of the mandrel and the planar surface region of the mandrel. The tool trench may be formed of a single continuous channel. The tool trench may be annular. The tool trench may be concentric with the curved surface region and the planar surface region, and located between the curved surface region and the planar surface region. The tool trench may have a depth of at least 150 μm, for example at least 190 μm, for example over at least 80 percent of its length, for example along substantially the whole of its length. The tool trench may have a depth of less than 1 mm, for example less than 0.5 mm, for example over at least 80 percent of its length (circumferential extent), for example along substantially the whole of its length. As used herein ‘depth’ refers to the extent in a direction parallel to the axis of rotation of the mandrel. The depth of the tool trench is measured relative to the planar surface region. It may be that the width (radial extent) of the trench is at least 0.5 mm, for example at least 1 mm, for example over at least 80 percent of its length (circumferential extent), for example along substantially the whole of its length (e.g., 50% or more, 75% or more, 90% or more, at least 95%, or at least 99% of the entire length).

The front surface may comprise a drainage channel located radially inboard of the tool trench. The front surface may comprise a drainage channel located radially outboard of the tool trench. The drainage channel may be concentric with the curved surface region, the planar surface region, and the tool trench. The drainage channel may be annular.

It may be that the width (radial extent) of the drainage channel is at least 0.5 mm, for example at least 1 mm, for example over at least 80 percent of its length (circumferential extent), for example along substantially the whole of its length (e.g., 50% or more, 75% or more, 90% or more, at least 95%, or at least 99% of the entire length). This width has been found to be advantageous in terms of allowing for the effective collection of wax by the channel. It may be that the drainage channel extends from the front surface of the mandrel to the back surface of the mandrel. Thus, the drainage channel may extend through the depth of the mandrel in the region of the front surface. The drainage channel may extend from a front surface of the mandrel to an edge of the mandrel.

The front surface of the mandrel may be configured such that a first portion, for example a planar surface region, of a blank abuts the planar surface region of the mandrel while a second portion, for example an optic zone, of the ophthalmic lens member blank is received in or on the curved surface region of the mandrel. The curved surface region of the mandrel may be curved (e.g., non planar) over the majority of, for example the whole of, its surface area. The curved surface region of the mandrel may be centrally located on the front surface of the mandrel. The planar surface region of the mandrel may extend around the majority of, for example the whole of, the perimeter of the curved surface region of the mandrel. The planar surface region of the mandrel may be annular. The planar surface region of the mandrel may be concentric with the curved surface region of the mandrel. The planar surface region of the mandrel may be radially outside the curved surface region of the mandrel. The planar surface region of the mandrel may be planar over the majority of, for example the whole of, its surface area.

The curved surface region of the mandrel may be a convex surface region. It will be appreciated that as used herein the term ‘convex surface region’ refers to a region that is convex with respect to the planar surface region of the mandrel. The convex surface region may be convex over the majority of, for example the whole of, its surface area. It may be that the convex surface region comprises and/or defines a dome, for example a hemispherical dome. The convex surface region may be configured to be received in a concave recess defined by the posterior surface of an ophthalmic lens member blank, for example while the ophthalmic lens member blank abuts the planar surface region of the mandrel.

The curved surface region of the mandrel may be a concave surface region. It will be appreciated that as used herein the term ‘concave surface region’ refers to a region that is concave with respect to the planar surface region of the mandrel. The concave surface region may be concave over the majority of, for example the whole of, its surface area. It may be that the concave surface region comprises and/or defines a bowl, for example a hemi-spherical bowl. The concave surface region may be configured to receive a convex protrusion defined by the anterior surface of an ophthalmic lens member blank, for example while the ophthalmic lens member blank abuts the planar surface region of the mandrel.

The mandrel may comprise a stem for mounting the mandrel on a machine tool. The mandrel may comprise a flange extending radially from the stem, for example at one end of the stem. It maybe that a front surface of the flange, for example the surface on the opposite side of the flange to the stem comprises and/or defines the planar surface region of the mandrel and/or the curved surface region of the mandrel. The mandrel may comprise a back surface, being the surface located on the opposite side of the flange to the front surface. In use the mandrel may rotate about the longitudinal axis of the stem. The diameter of the stem may be less than 50% of the diameter of the mandrel-flange. The front surface of the mandrel may be substantially perpendicular (not withstanding any channels formed therein) to the stem (e.g., within 10 degrees or less perpendicular).

It may be that the front surface of the mandrel comprises an optic zone and a peripheral zone. It may be that the optic zone of the front surface is centred on the front surface. The curved surface region of the mandrel may comprise, consist essentially of, or consist of the optic zone. It may be that the mandrel is configured such that the optic zone of the front surface is aligned with the optic zone of a lens member blank and/or the curved surface region of a lens member blank when said blank is received on the front surface. It may be that the peripheral zone of the front surface of the mandrel is radially outside the optic zone, for example the peripheral zone of the mandrel may be annular and surround the optic zone. The planar surface region of the mandrel may comprise, consist essentially of, or consist of the peripheral zone. It may be that the mandrel is configured such that the peripheral zone of the front surface and/or the planar surface region is aligned with the peripheral zone of a lens member blank when said blank is received on the front surface.

The planar surface region of the mandrel may have an outer diameter from 4 mm to 20 mm inclusive, for example from 10 mm to 20 mm inclusive. The curved surface region of the mandrel may be circular in shape or substantially circular in shape (e.g., having circular features) and may have a diameter from 2 mm to 10 mm inclusive. In some embodiments, the planar surface region of the mandrel has an outer diameter from 13 mm to 15 mm, and the curved surface region of the mandrel has a diameter from 7 mm to 9 mm.

It may be that the mandrel comprises one or more through-holes extending from the planar surface region of the front surface to the back surface of the mandrel. The mandrel may be configured such that in use, wax received in said through-holes can be used to retain a portion of the ophthalmic lens member located radially outside the tool trench on the mandrel (e.g. said portion severed by the cutting tool).

The mandrel may comprise a retaining member moveable between a first configuration in which the retaining member allows the ophthalmic lens member blank to move relative to the mandrel and a second configuration in which the retaining member prevents movement of at least a portion of the ophthalmic lens member blank, said portion being located radially outside the tool trench. The retaining member may be or form part of a clip or a clamp. The retaining member may comprise an annular resiliently deformable member, for example an o-ring or other washer, located in the front-recess such that the retaining member is compressed between a peripheral edge of the blank and the sidewall(s) of the front-recess when a blank is received in the front-recess.

The mandrel may comprise one or more first magnets, for example located at or immediately below the planar surface region and/or radially outside the tool trench. It may be that the mandrel is configured such that, in use, a second magnet(s) and/or magnetic member(s) located on the opposite side of the blank to the first magnet(s) is attracted toward said first magnet(s) and thereby holds a portion of the blank located radially outside the tool trench against the first surface. In one additional aspect there is provided a kit of parts comprising a mandrel comprising said first magnet(s) and having any of the other features described above and/or below, and a set of second magnet(s) and/or magnetic member(s).

In a third aspect of the disclosure, there is provided an ophthalmic lens and/or a batch of at least one thousand ophthalmic lenses, for example contact lenses. It may be that each lens comprises at least one ophthalmic lens member produced using the method of the first or fourth aspects and/or using the mandrel of the second aspects. It may be that each lens member (or lens) has an optic zone and a peripheral zone. The optic zone having an optical axis that is coaxial with a geometric axis of the lens member (or lens).

Prior art methods of machining a lens using wax to hold the lens member on a mandrel provide a high number of lenses with the optical axis misaligned with the geometric axis due to the lens member blank being misaligned with the axis of rotation of the mandrel. Accordingly, no known method that uses wax results in an error rate of less than 1 in 1000 lenses for these defects. Lenses produced using the method and/or mandrel of the present disclosure may avoid such defects by improving the accuracy, precision and/or repeatability with which the lens member blank is positioned on the mandrel, thereby allowing the production of a batch in accordance with the third aspect, particularly when producing cap-type lens members.

It will be appreciated that the lenses of a batch are sequentially produced. As used herein ‘sequentially produced’ means the batch is composed of lenses produced one after another without any intervening lenses which do not form part of the batch.

The optical axis may be defined as the axis about which the optic zone is rotationally symmetric. The geometric axis may be defined as the axis about which the edge of the lens or lens member is rotationally symmetric.

The ophthalmic lens member may have a convex or concave surface region having a wax residue thereon. It may be that the ophthalmic lens member does not have a planar surface region (for example because the planar surface region of the ophthalmic lens member blank has been severed). It may be that the peripheral edge of the ophthalmic lens member is defined by the tool trench. The or each ophthalmic lens member may be produced using the method of the present disclosure. It may be that at least one of said ophthalmic lens members is produced using the method of the present disclosure. The ophthalmic lens may comprise an ophthalmic lens member assembly comprising an ophthalmic lens member produced using the method of the first aspect and/or the mandrel of the second aspect, and having any of the other features of an ophthalmic lens member assembly as described above.

The ophthalmic lens may comprise a central optic zone and an annular peripheral zone surrounding the central optic zone. It may be that said wax residue is located in the optic zone.

The ophthalmic lens may comprise one or more optical components, for example diffractive optical elements, and electrically-switchable components, including liquid crystal cells. The ophthalmic lens may comprise one or more optical components located between first and second ophthalmic lens members. One or both of the first and second ophthalmic lens member may be produced using the method of the first aspect and/or the mandrel of the second aspect.

The ophthalmic lens may comprise an ophthalmic lens member produced by machining an ophthalmic lens member blank using the methods and apparatus of the present disclosure. The ophthalmic lens may comprise a blank machined on its anterior surface and/or its posterior surface and a peripheral edge that has been cut (e.g., where said portion has been severed, and in contrast to a molded peripheral edge). The ophthalmic lens may comprise a single blank machined on its anterior surface and/or its posterior surface and having a cut peripheral edge. Alternatively, the ophthalmic lens may comprise two (or more) blanks, each blank being machined on its anterior surface and/or its posterior surface and having a cut peripheral edge. The ophthalmic lens may comprise a first lens member machined on its posterior surface and a second lens member machined on its anterior surface, for example wherein the second lens member is affixed to the first lens member, optionally, with one or more optical components located therebetween, the first and/or second lens member having a cut peripheral edge. In some embodiments, said first and second lens members define an encapsulation component, that is itself then encapsulated within lens material to form the lens. In other embodiments, the ophthalmic lens may be formed by the first and second lens members only.

As used herein, an ophthalmic lens may be a spectacle lens or a contact lens. A lens may comprise one or more lens members produced by machining one or more lens member blanks. A contact lens may comprise one or more contact lens members produced by machining one or more contact lens member blanks.

A contact lens may be a rigid contact lens or a soft contact lens such as a hydrogel contact lens or a silicone hydrogel contact lens. Thus, the blank may be a contact lens member blank, for example a rigid contact lens member blank or a soft contact lens member blank such as a hydrogel contact lens member blank or a silicone hydrogel contact lens member blank. As used herein, the term contact lens refers to an ophthalmic lens that can be placed onto the anterior surface of the eye. It will be appreciated that such a contact lens will provide clinically acceptable on-eye movement and not bind to the eye of a person.

The contact lens may be for correcting or improving vision associated with myopia, presbyopia, hyperopia, astigmatism or another refractive anomaly. The contact lens may be a soft contact lens, such as a hydrogel contact lens or a silicone hydrogel contact lens. The contact lens may be a rigid gas permeable contact lens. The contact lens may be a scleral contact lens.

The contact lens (and therefore the contact lens member blank(s)) may comprise an elastomer material, a silicone elastomer material, a hydrogel material, or a silicone hydrogel material, or combinations thereof. As understood in the field of contact lenses, a hydrogel is a material that retains water in an equilibrium state and is free of a silicone-containing chemical. A silicone hydrogel is a hydrogel that includes a silicone-containing chemical. Hydrogel materials and silicone hydrogel materials, as described in the context of the present disclosure, have an equilibrium water content (EWC) of at least 10% to about 90% (wt/wt). In some embodiments, the hydrogel material or silicone hydrogel material has an EWC from about 30% to about 70% (wt/wt). In comparison, a silicone elastomer material, as described in the context of the present disclosure, has a water content from about 0% to less than 10% (wt/wt). Typically, the silicone elastomer materials used with the present methods or apparatus have a water content from 0.1% to 3% (wt/wt). Examples of suitable lens formulations include those having the following United States Adopted Names (USANs): methafilcon A, ocufilcon A, ocufilcon B, ocufilcon C, ocufilcon D, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, lotrafilcon B, somofilcon A, riofilcon A, delefilcon A, verofilcon A, kalifilcon A, and the like.

Alternatively, the lens (and therefore the lens member blank(s)) may comprise, consist essentially of, or consist of a silicone elastomer material. For example, the lens may comprise, consist essentially of, or consist of a silicone elastomer material having a Shore A hardness from 3 to 50. The shore A hardness can be determined using conventional methods, as understood by persons of ordinary skill in the art (for example, using a method DIN 53505). Other silicone elastomer materials can be obtained from NuSil Technology or Dow Chemical Company, for example.

Alternatively, the lens (and therefore the lens member blank(s)) may comprise polymethyl methacrylate (PMMA).

The contact lens or contact lens member blank may be substantially circular in shape. The contact lens/lens member blank may have a diameter from 4 mm to 20 mm inclusive, for example from 10 mm to 20 mm inclusive. The optic zone of the contact lens/blank may be substantially circular in shape and may have a diameter from 2 mm to 10 mm inclusive. In some embodiments, the contact lens/blank has a diameter from 13 mm to 15 mm, and the optic zone has a diameter from 7 mm to 9 mm. The contact lens/blank may have a convex anterior surface. The contact lens/blank may have a concave posterior surface and/or a convex anterior surface.

In a fourth aspect of the invention, there is provided a method of producing a contact lens (or other ophthalmic lens) comprising at least one contact lens member (or ophthalmic lens member), the method comprising producing the contact lens member (or ophthalmic lens member) using the method of the first aspect and/or the mandrel of the second aspect.

The method of producing a contact lens (or other ophthalmic lens) may comprise carrying out one or more of the following steps: removing the (contact) lens member from the mandrel, for example by melting the wax; placing the (contact) lens member in contact with an aqueous composition to produce a hydrated lens member; placing the (contact) lens member in contact with a (contact) lens packaging solution; and/or placing the (contact) lens member in a blister package, and optionally wherein the blister package is subsequently sealed and sterilized.

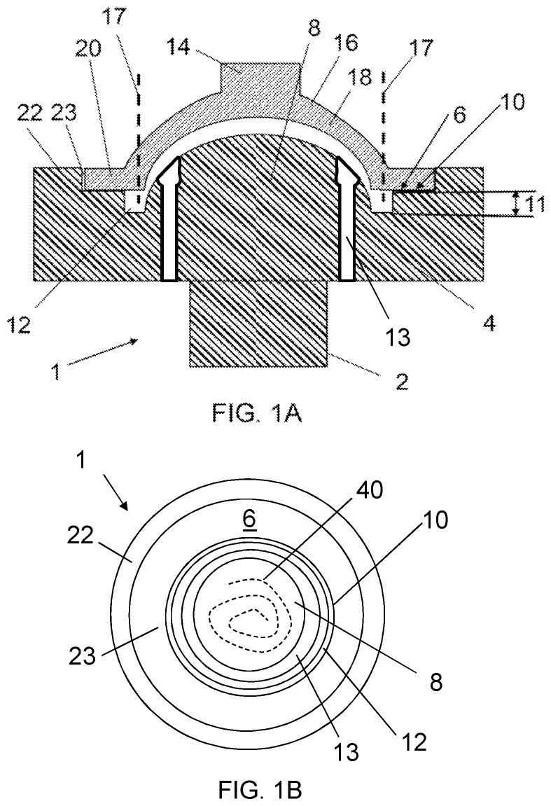

With reference to FIG. 1A and FIG. 1B, a first embodiment of the present disclosure is discussed. FIG. 1A shows a schematic cross-sectional view of a mandrel 1. The mandrel comprises a stem 2 and a flange 4 at one end of the stem 2 and extending radially outward from the stem 2. The flange 4 defines part of a front surface 6 of the mandrel located on the opposite side of the flange 4 to the stem 2. The front surface 6 comprises a dome 8 and annular planar surface region surrounding the dome 8. A tool trench 12 extends around the base of the dome 8. A drainage channel 13 extends around the dome 8, inboard of the tool trench 12. A rim 22 extends around annular planar surface region 10 and thereby forms a front-recess 23. In FIG. 1A, a contact lens member blank 16 is located on top of the front surface 6 and partially within front-recess 23. The contact lens member blank 16 has an anterior surface comprising a bowl 18 surrounded by a peripheral flange 20. The dome 8 is located in the bowl 18 and the peripheral flange 20 contacts the annular planar surface region 10 in FIG. 1A. The contact lens member blank 16 comprises a spigot 14 extending upwards in FIG. 1A, away from the bowl 18 and peripheral flange 20. FIG. 1B shows a plan view of the mandrel 1 of FIG. 1A, without the contact lens member blank 16. A helical groove 40 (shown by a dashed line in FIG. 1B) is cut into the surface of the dome 8. It will be appreciated that other shapes of groove can be used. The depth of the tool trench 12 with reference to the annular planar surface region 10 is labelled 11 in FIG. 1A.

In use, wax is applied to the dome 8. The contact lens member blank 16 is then pushed onto the wax, until the peripheral flange 20 is in contact with the annular planar surface region 10. The contact between the peripheral flange 20 and the annular planar surface region 10 may reduce the risk of and/or degree of misalignment between the contact lens member blank 16 and the mandrel 1. Wax located between the contact lens member blank 16 and dome 8 flows into and collects in drainage channel 13 as the contact lens member blank 16 is pushed onto the dome 8. Collection of wax in the drainage channel 13 reduces or prevents wax flowing onto the annular planar surface region 10, where the presence of wax could lead to misalignment between the contact lens member blank 16 and the mandrel 1. Collection of wax in the drainage channel 13 reduces or prevents wax flowing into the tool trench 12, where it may contaminate the cutting tool. Deliberately roughening the surface of the dome 8 with helical groove 40 may increase the amount of wax held on the dome, and thereby further reduce and/or prevent the flow of wax on the annular planar surface region 10. The mandrel 1 is mounted on a machine tool and the posterior surface of the contact lens member blank 16 is machined to remove the spigot 14. A cutting tool is then used to remove the peripheral flange 20 of the contact lens member blank 16—the cutting tool passes through the blank and into the tool trench 12 thereby severing the peripheral flange 20 from the remainder of the contact lens member blank 16 as the mandrel rotates relative to the tool. The cutting tool passes along the whole of the length of the tool trench 12 and thereby the whole circumference of the bowl 18. A dashed line labelled 17 in FIG. 1A illustrates the boundary along which the peripheral flange 20 is severed from the remainder of the contact lens member blank 16.

While the present embodiment has been described with reference to a contact lens member blank it will be appreciated that the disclosure may also find application with other types of ophthalmic lens member blanks. Similarly, while the mandrel of FIG. 1A is shown with a convex curved front surface region and the anterior surface of the contact lens member blank 16 presented for machining, it will be appreciated the disclosure may also find application with a mandrel having a concave curved front surface region and the posterior surface of the contact lens member blank presented for machining. While the present embodiment refers to a spigot 14 and rim 22 it will be appreciated that in some embodiments one or more of these features may be absent.

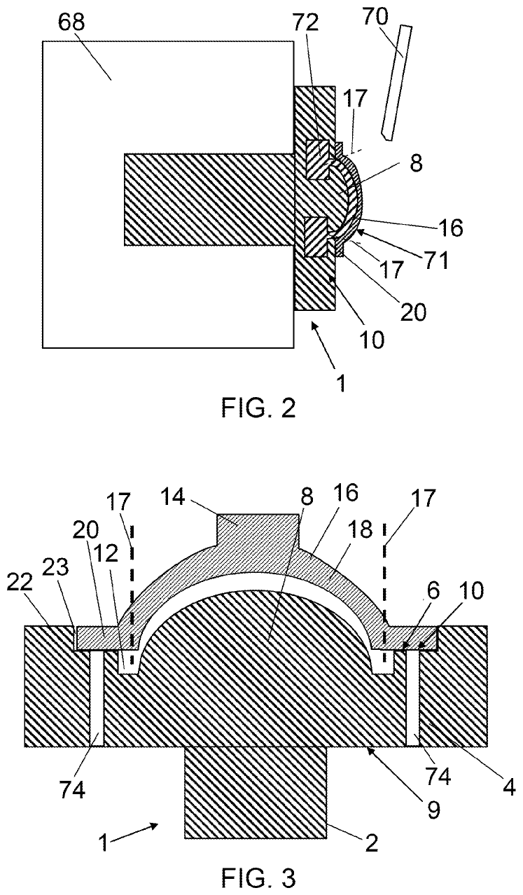

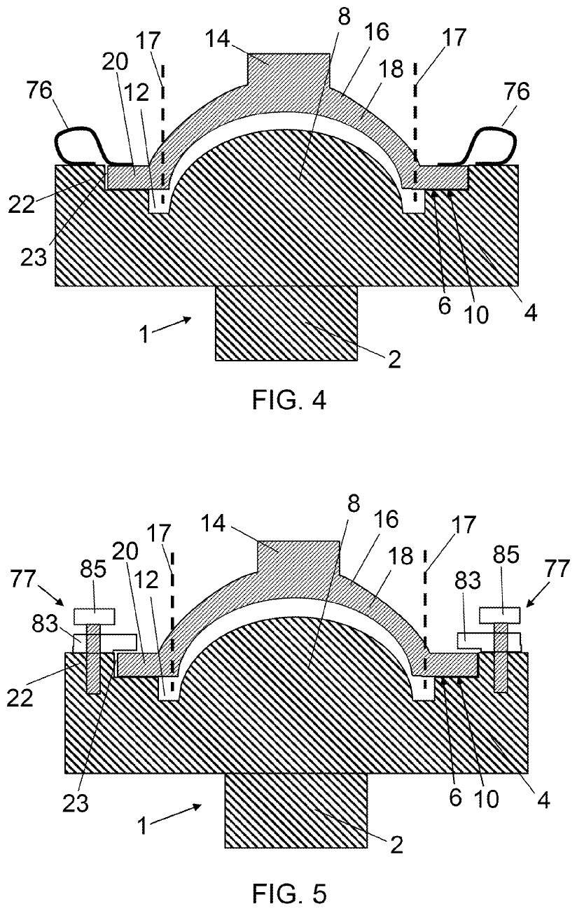

FIG. 2 shows a mandrel 1 in accordance with an example embodiment of this disclosure mounted in a chuck 68 of a lathe (not shown) for cutting with cutting tool 70. Wax 72 covers dome 8 and fills the drainage channel. Like reference numerals denote like elements as between FIG. 1A and FIG. 2 (e.g., the peripheral flange is labelled 20 in both FIG. 1A and FIG. 2). The mandrel 1 of FIG. 2 differs in shape from the mandrel of FIG. 1A and does not include a rim 22 forming a front-recess 23. The edges of the lens member blank 16 abuts the annular planar surface region 10. In use, the cutting tool 70 (not shown in scale in FIG. 2) severs the peripheral flange of the contact lens member blank 16 by passing along the dashed line 17. While FIG. 4 shows the mandrel 1 in a lathe, it will be appreciated that other machining operations can be carried out using the mandrel of the present disclosure, for example polishing and/or grinding. In some embodiments, cutting tool 70 is also used to lathe the front surface 71 of the contact lens member blank 16.

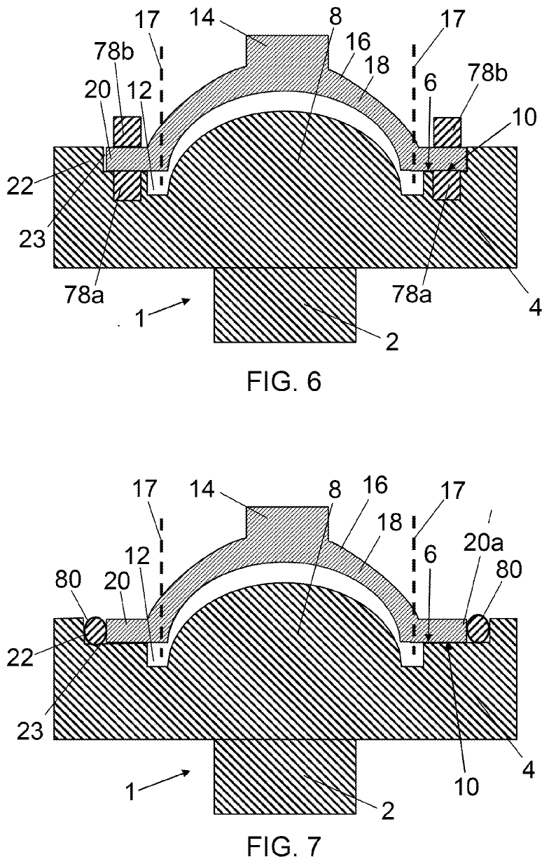

FIG. 3, FIG. 4, FIG. 5, FIG. 6 and FIG. 7 show mandrels 1 in accordance with example embodiments of this disclosure. Only those elements of the mandrel of FIG. 3, FIG. 4, FIG. 5, FIG. 6 and FIG. 7 which differ with respect to FIG. 1A will be discussed here. Like reference numerals denote like elements as between FIG. 1A and FIG. 3/FIG. 4/FIG. 5/FIG. 6/FIG. 7 (e.g., the peripheral flange is labelled 20 in all those figures). FIG. 3, FIG. 4, FIG. 5, FIG. 6 and FIG. 7 do not show a drainage channel 13, but it will be appreciated that such a drainage channel 13 could be used in any of these example embodiments.

In the mandrel 1 of FIG. 3 through-holes 74 extend from the front surface 6 (where they are located in the base of the front-recess 23) to a rear surface 9 of the mandrel (the rear surface 9 being located on the opposite side of the flange 4 to the front surface). In use, after the contact lens member blank 16 has been placed on the mandrel 1 wax may be supplied to through-holes 74 from the rear of the mandrel. Once set, the wax in the through-holes 74 retains the contact lens member blank 16 on the mandrel during machining, and retains the peripheral flange 20 on the mandrel 1 after the peripheral flange 20 has been severed from the rest of the contact lens member blank 16. In an alternative embodiment, a drainage channel is provided inboard of tool trench 12, so that wax from the through-holes 74 cannot reach the curved surface region.

In the mandrel 1 of FIG. 4 clips 76 in the form of torsion springs are mounted on the front surface 6 of the mandrel and retain the peripheral flange 20 on the mandrel 1 after the peripheral flange 20 has been severed from the rest of the contact lens member blank 16. In FIG. a clamp 77 replaces clips 76. The clamp 77 comprises a clamp member 83 and a threaded bolt 85, which passes through the clamp member 83 and engaged with a corresponding thread (not shown) in the flange 2. In use, tightening the bolt 85 causes the clamp member 83 to press against the peripheral flange 20, such that the peripheral flange 20 is held against the front surface 6 after it has been severed from the rest of the contact lens member blank 16.

In the mandrel 1 of FIG. 6, first magnets 78a are located at the planar surface 10 of the mandrel 1. In use, second magnets 78b placed on the opposite side of the ophthalmic lens member blank 16 to the first magnets 78a are attracted to first magnets 78a and thereby hold the peripheral flange 20 against the front surface 6 against the front surface 6 after it has been severed from the rest of the contact lens member blank 16 using magnetic attraction.

In the mandrel 1 of FIG. 7 an o-ring 80 is located between the peripheral edge 20a of the peripheral flange 20 and the rim 22. In use, the o-ring 80 is compressed as the ophthalmic lens member blank 16 is pushed onto the wax on the dome 8, and then retains the peripheral flange on the mandrel 1 after the peripheral flange 20 has been severed from the rest of the contact lens member blank 16. In FIG. 7 an o-ring 80 is used, but it will be appreciated that other types of washer, or resilient member could be used.

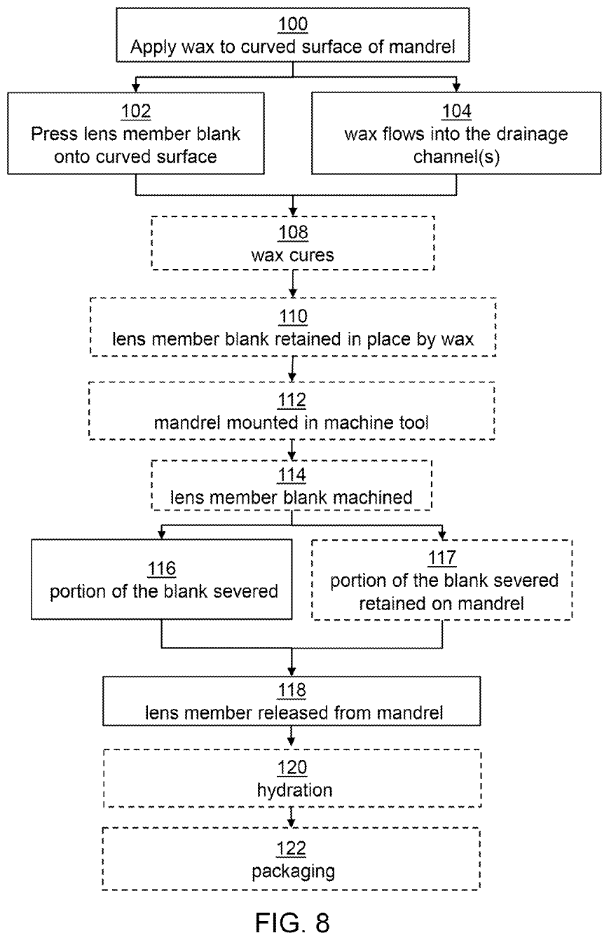

FIG. 8 shows a flow chart of an example method in accordance with the present disclosure. Wax is applied 100 to the curved surface of the mandrel. A lens member blank is the pressed 102 onto the curved surface, until the lens member blank abuts the planar surface of the mandrel. While the lens member blank is being pressed 102 onto the curved surface wax flows 104 into the drainage channel(s). A portion of the lens member blank is then severed 116 by passing a cutting tool through the lens member blank until the cutting tool is at least partially received in the drainage channel(s). Optionally, the method may include the following further steps (individually or in combination), with optional steps being indicated with a dashed line in FIG. 8. After the lens blank is pressed 102 onto the curved surface, and the wax flows 104 into the drainage channel(s), the wax is then allowed to cure 108. The lens is then released and the lens member blank is retained 110 in place by the wax. The mandrel is then mounted 112 in a lathe (or other machine tool), for example by the stem of the mandrel being received in a chuck of the lathe. The anterior and/or posterior surface of the lens member blank is then machined 114 before the portion of the lens member blank is severed 116. After the portion of the lens member blank is severed 116, the lens member is then released 118 from the mandrel, for example by melting the wax. Optionally, the portion severed from the lens member blank is retained 117 on the mandrel 1, for example by wax, clips, clamps, an o-ring or other washer and/or magnets as described above. Optionally, further conventional steps may be carried out to produce a finished, packaged lens comprising the lens member. These may include one or more of placing the lens member in contact with an aqueous composition to produce a hydrated lens member (a hydration step 120); and a packaging step 122 in which the lens member is placed in a blister package in contact with a storage solution, and said blister package is subsequently sealed and sterilized.

In an alternative to steps 100, 102 and 104 of the method of FIG. 8, a lens member blank is placed onto the curved surface, until the lens member blank abuts the planar surface of the mandrel. While the lens member blank is held in place on the curved surface, wax is provided to through-holes in the mandrel via the back surface of the mandrel. As in the method of FIG. 8, the wax is then allowed to cure 108, and the lens member blank is retained 110 in place by the wax. However, in this alternative, it is the wax in the through-holes, rather than wax on the curved surface that retains the lens member blank.

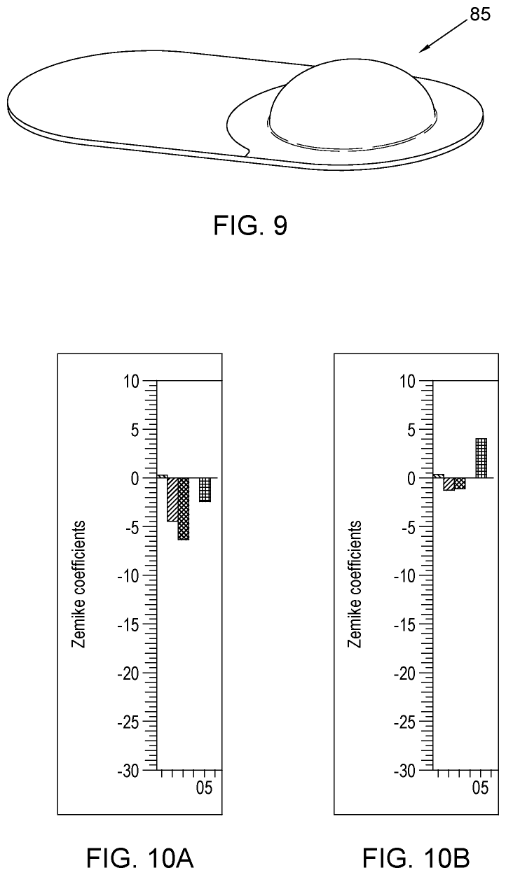

FIG. 9 shows a contact lens blister package 85 that may be used to store a contact lens comprising a contact lens member in accordance with an embodiment.

A previous method of machining a lens member blank involved using a wax block to mount the blank on a mandrel taking the form of a constant diameter rod with a domed end (i.e., without the planar surface and drainage channel of the present disclosure). Without wishing to be bound by theory, it is believed that this previous method had an increased risk of mounting the wax and/or blank out of position (e.g., off-centre or tilted). The resulting cutting errors are believed to cause an unwanted change in the thickness of the lens member from one side to the other, and this additional wedge-shape typically results in an optical tilt aberration in the finished lens. FIG. 10A shows values of Zernike coefficients of tilt and other low-order optical aberration terms for a lens member lathed using the previous (rod-like) mandrel. FIG. 10B shows values of Zernike coefficients of tilt and other low-order optical aberration terms for a lens member having a concave region and no peripheral flange, and being produced using the method of the present disclosure. It can be seen that the values of the lower order coefficients are significantly lower in magnitude in FIG. 10B, thereby indicating that methods and apparatus of the present disclosure reduce errors during the machining step.

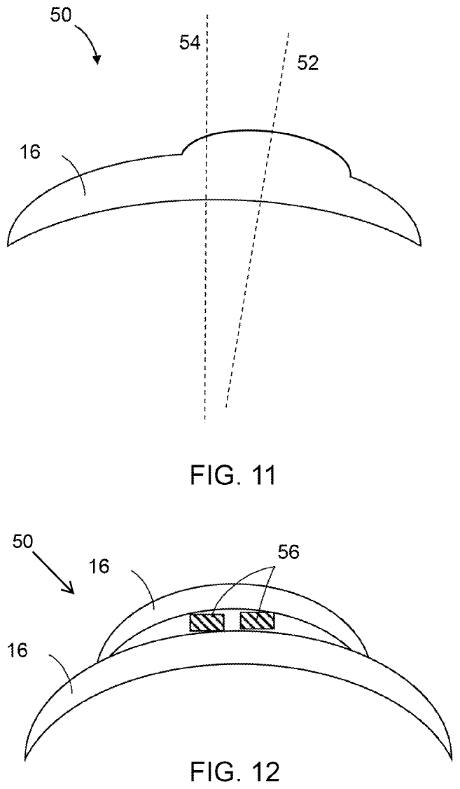

FIG. 11 shows a schematic example of a lens 50 formed from a single lens member blank 16 machined using the prior art method in which the lens member blank is placed on a block of wax. The lens 50 includes an optic zone having rotational symmetry about optical axis 52. The edges of the lens 50 are rotationally symmetric about geometric axis 54. Due to a misalignment of the lens 50 with the rotational axis during machining, the optical axis 52 is out of alignment with the geometric axis 54.

FIG. 12 shows an example of a lens 50 comprising two lens members 16 made in accordance with the present disclosure and having optical components 56 sandwiched there between.

Whilst the present disclosure has been described and illustrated with reference to particular embodiments, it will be appreciated by those of ordinary skill in the art that the disclosure lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. A method of producing an ophthalmic lens member, the method comprising:
mounting an ophthalmic lens member blank on a mandrel for machining, the mandrel having a front surface comprising a planar surface region, a curved surface region and a tool trench located between the curved surface region and the planar surface region; and
mounting the mandrel on a machine tool; and then
severing a portion of the ophthalmic lens member blank by passing a cutting tool through the ophthalmic lens member blank until a portion of the cutting tool is received in the tool trench.

2. The method according to claim 1, wherein the ophthalmic lens member blank comprises an anterior and/or posterior surface having a curved surface region and a planar surface region and said portion of the blank that is severed comprises said planar surface region(s).

3. The method according to claim 2, wherein the ophthalmic lens member blank is mounted on the mandrel with said planar surface region of the ophthalmic lens member blank abutting the planar surface region of the mandrel.

4. The method according to claim 1, wherein said portion severed from the blank is retained on the mandrel after it has been severed.

5. The method according to claim 1, wherein the front surface of the mandrel comprises a drainage channel, and mounting the ophthalmic lens member blank on the front surface of the mandrel comprises applying wax to the curved surface region and placing the blank on the wax thereby causing wax to flow into the drainage channel from the curved surface region.

6. The method according to claim 5, wherein wax from the curved surface region is retained by the drainage channel such that substantially no wax flows from the curved surface region of the front surface to the tool trench.

7. The method according to claim 5, wherein the mandrel comprises one or more thorough-holes located in the planar surface region, and said portion severed from the blank is retained on the mandrel by wax located in said through-holes, and the wax is provided to said through-holes after the ophthalmic lens member blank has been mounted on the mandrel using wax applied to the curved surface region of the mandrel.

8. The method according to claim 5, wherein said portion severed from the blank is retained on the mandrel by one or more retaining members mounted on the mandrel and the method comprises said retaining member(s) moving from a first configuration, in which the retaining member allows the ophthalmic lens member blank to move relative to the mandrel, to a second configuration in which the retaining member prevents movement relative to the mandrel of at least a portion of the ophthalmic lens member blank located radially outside the drainage channel.

9. The method according to claim 8, wherein the or each retaining member is or forms part of a clip or a clamp.

10. The method according to claim 8, wherein the front surface of the mandrel comprises a front-recess in which at least a portion of the ophthalmic lens member blank is received when mounted on the mandrel, said front-recess being defined by one or more sidewalls and a base; and wherein said portion severed from the blank is retained on the mandrel by a resiliently deformable retaining member located in said front-recess and which is deformed during the step of placing the ophthalmic lens member blank on the wax.

11. The method according to claim 5, wherein said portion severed from the blank is retained on the mandrel using one or more magnet(s), for example wherein the mandrel comprises one or more first magnets and one or more second magnets and/or one or more magnetic members are located on the other side of the lens member blank to the first magnet(s) such that the said portion severed from the blank is retained on the mandrel by the attractive force between the first and second magnet(s) and/or the first magnet(s) and the magnetic member(s).

12. The method according to claim 1, wherein the mandrel comprises one or more through hole(s) extending from a back surface of the mandrel to the front surface of the mandrel, and wherein mounting the ophthalmic lens member blank on the front surface of the mandrel comprises providing wax to each of said through hole(s) via an opening of the through hole on the back surface of the mandrel.

13. The method according to claim 12, wherein said through hole(s) are located in the planar surface region of the front surface of the mandrel.

14. The method according to claim 12, wherein said portion severed from the blank is retained on the mandrel by wax located in said through hole(s).

15. A method of producing a contact lens comprising at least one contact lens member, the method comprising producing the contact lens member using the method of any previous claim, and then carrying out one or more of the following steps:
removing the contact lens member from the mandrel, for example by melting the wax;
placing the contact lens member in contact with an aqueous composition to produce a hydrated lens member;
placing the contact lens member in contact with a contact lens packaging solution; and/or
placing the contact lens member in a blister package, and wherein the blister package is subsequently sealed and sterilized.

16. A mandrel for holding an ophthalmic lens member blank during machining, the mandrel having a front surface for receiving an ophthalmic lens member blank to be machined; the front surface comprising;
a planar surface region;
a curved surface region; and
a tool trench located between the curved surface region and the planar surface region;
wherein the depth of the tool trench is at least 150 μm when measured with respect to the planar surface region.

17. The mandrel according to claim 16, further comprising a drainage channel located radially inboard of the tool trench such that wax applied to the curved surface region flows into the drainage channel.

18. The mandrel according to claim 16, comprising one or more through-holes extending from the planar surface region of the front surface to a back surface of the mandrel, such that, in use, wax received in said through-holes can be used to retain a portion of the ophthalmic lens member blank.

19. The mandrel according to claim 16, comprising a retaining member moveable between a first configuration in which the retaining member allows the ophthalmic lens member blank to move relative to the mandrel and a second configuration in which the retaining member prevents movement of at least a portion of the blank, said portion being located radially outside the drainage channel.

20. The mandrel according to claim 16, comprising one or more magnets located at or immediately under the planar surface, said magnet(s) being configured for use in retaining a portion of the ophthalmic lens member blank.

21. An ophthalmic lens comprising at least one ophthalmic lens member produced using the method of claim 1, said ophthalmic lens member comprising an optic zone, the optic zone having an optical axis that is coaxial with a geometric axis of the lens member and wherein said member comprises a machined anterior and/or posterior surface and a cut peripheral edge.

22. A batch of at least 1000 ophthalmic lenses, each ophthalmic lens comprising at least one ophthalmic lens member produced using the method of claim 1, said at least one ophthalmic lens member comprising an optic zone, the optic zone having an optical axis that is coaxial with a geometric axis of the lens member and wherein said member comprises a machined anterior and/or posterior surface and a cut peripheral edge.

23. The ophthalmic lens according to claim 21, wherein the lens is contained in a blister package.
